(19) United States
(12) Patent Application Publication
(10) Pub. No.: US 2012/0233264 A1
(43) Pub. Date: Sep. 13, 2012

(54) Method and System for Vehicle Messaging

(76) Inventor: Jeffrey Krupman, San Francisco, CA (US)

(21) Appl. No.: 13/043,427

(22) Filed: Mar. 8, 2011

(51) Int. Cl. G06F 15/16

(52) U.S. Cl. 709/206

(57) ABSTRACT

A system and method are described for vehicle messaging. The system allows for a first user to send a message to a second user based on a vehicle identifier, which is an alphanumeric or other symbolic designator associated with the second user's vehicle or a vehicle in which the second user is a driver or passenger. The vehicle identifier can be a vehicle license plate, a vehicle identification number (VIN), or some other designator associated with the vehicle. The vehicle identifier may be displayed on a sticker or placard attached to the vehicle. The system and method include various ways to relay the message to the second user.

### CROSS REFERENCE TO RELATED APPLICATIONS

None

### TECHNICAL FIELD

Embodiments of the invention generally relate to wireless messaging (such as sms or mms), electronic mail, telephone call (including over voice), Internet, instant messaging (IM), and other communications applications, including application service providers (ASPs), such as social networking applications. Specifically, embodiments of the invention relate to systems and methods for communicating based on a vehicle identifier.

### BACKGROUND

The growth in popularity of cellular phones, sms text messaging, mms messaging, electronic mail, and other forms of communication provided by ASPs and others, have offered users various methods to communicate with each other. With the development of mobile phones and mobile in-vehicle communications devices, people now have access to one or more of these means of communication in a mobile or in-vehicle device. The problem still remains though that in order to communicate, one must have a person's email address, phone number, or ASP (e.g., a Facebook, Twitter, or IM) identity. A person cannot communicate with the driver, passenger, or owner of an automobile, truck, motorcycle, boat or other means of transportation (“vehicle”), unless he knows a phone number, email address, ASP identity, or in-vehicle device number to initiate communication. This inability to initiate communication solely based on an identifier associated with a vehicle can lead to significant costs, including costs arising from traffic accidents, illegal parking, and other infractions. Accordingly, a need has arisen for a system which allows users to send messages to others using vehicle identifiers, such as vehicle identification numbers (VINs), license plate numbers, or other alphanumeric designators associated with a vehicle.

### SUMMARY

In accordance with the teachings of the present invention, a method and system for vehicle messaging is provided, wherein messaging may include any form of communication, such as e-mails, text messaging, multimedia messaging, telephone communication, instant messaging, and general ASP messaging, such as social networking applications. One embodiment of the invention is a system that receives a message from a first user. The system then relays the message to another second user based upon a vehicle identifier.

In another embodiment, the first user enters the message and vehicle identifier into a user interface. The system then relays the message to another second user based upon the vehicle identifier. In an alternative embodiment, the first user sends a message to multiple other users in a “broadcast” style transmission. In yet another embodiment, multiple users simultaneously communicate in a “conference call” style format.

The vehicle identifier is a unique alphanumeric string, or set of such strings, or other series of symbols, associated with a vehicle, such as a vehicle license plate number or VIN number. Additionally, the vehicle identifier may be another unique designator, which may be imprinted on or attached to the vehicle. For example, the designator may be displayed on a sticker attached to the vehicle and may instruct the first user how to contact the second user.

### BRIEF DESCRIPTION OF THE DRAWINGS

The accompanying drawings taken in conjunction with the detailed description will assist in making the advantages and aspects of the disclosure more apparent.

FIG. 1 is a block diagram of a general system embodiment also showing how the users interact with the system.

FIG. 2 is the database schema of a general system embodiment

FIG. 3 is a flow chart showing how the computer receives a message, parses a received message, validates the format, queries the database and forwards it to the registered user.

### DETAILED DESCRIPTION

Reference will now be made in detail to the present embodiments discussed herein, illustrated in the accompanying drawing. The embodiments are described below to explain the disclosed system and method by referring to the figures using like numerals. It will be nevertheless be understood that no limitation of the scope is thereby intended, such alterations and further modifications in the illustrated device, and such further applications of the principles as illustrated therein being contemplated as would normally occur to one skilled in the art to which the embodiments relate.

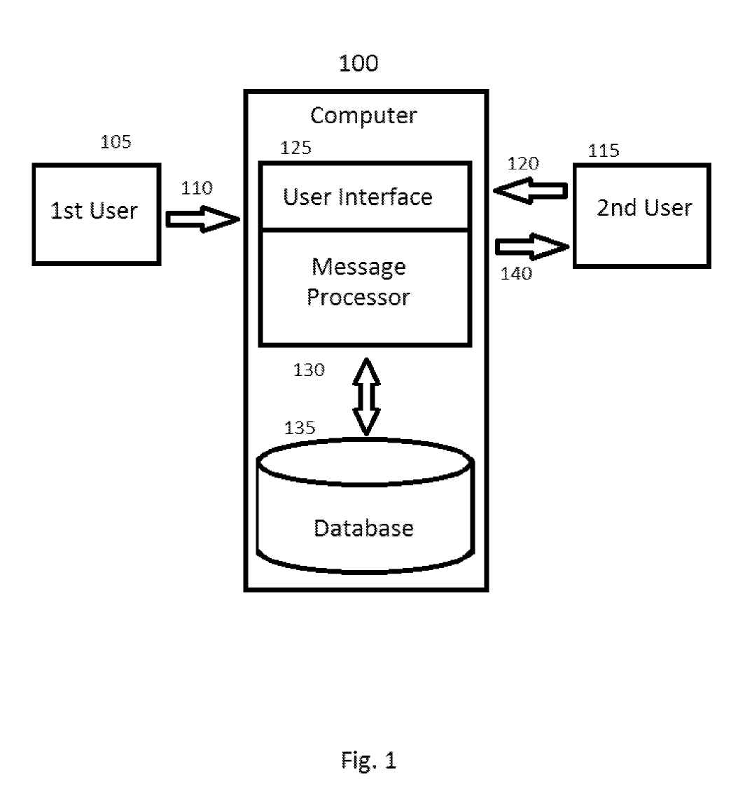

A system and method for vehicle messaging is provided whereby a first user may send a message to a second user based on an identifier associated with the second user's vehicle. As illustrated in FIG. 1, system 100 shows a first user 105, sending a message 110 to a second user 115, who previously registered 120 with the computer, which includes a user interface 125, message processor 130, and database 135, which relays the message 130. In an alternative embodiment, the second user need not register with the computer, and instead may be pre-populated in the database 135

A first user 105 is the user who interacts with the computer and sends the message to the computer with the purpose that the message be relayed to the owner, driver or passenger of the vehicle. The first user may have registered 120 on the computer's user interface 125; alternatively, no registration may be required. A first user's registration information is stored within the database 135. The message 110 can be sent to the computer by sms or mms message, telephone, email, IM, an ASP, including social networking applications, or directly by accessing the application or website's user interface 125, or via an application that accesses such a website, such an application running on a mobile phone or an in-vehicle communication device. In an alternative embodiment, the first may send a message to multiple other users in a “broadcast” style transmission. Additionally, multiple users may simultaneously communicate in a “conference call” style format.

The second user 115 is the user who receives automatically from the computer a message which was initially sent by the first user. In an alternative embodiment, the second user 115 receives the message via a relay from a second computer, which may be part of a centralized or decentralized/peer-to-peer network. In another embodiment, the second user 115 may instead be a group of users to whom the first user sends a “broadcast” message. The second user 115 may have previously registered 120 with the computer's user interface 125. Alternatively, the second user's relevant data may be pre-populated in the database 135. If the second user registers, registration 120 may require the creation of a login and password, which gives the second user 115 exclusive access to his personal information and account. The user then can add vehicle identifiers to his account, which may take the form of license plates, VIN numbers, or other vehicle designators. Alternatively, such vehicle identifiers may be pre-populated in the database and associated with specific vehicles or groups of vehicles. Lastly, second users must set up their preferred means of receiving messages 140, such as via sms or mms message, IM, voice call, electronic mail, or ASP by supplying a phone number, electronic mail address, IM address, ASP identity, in-vehicle device number, or other communications device designator. A second user's registration information is stored within the database 135. During registration, the user interface 125 checks that user's name, login, vehicle identifiers, and communication identifiers are unique to that user alone and are valid.

Sample source code, developed in Ruby on Rails, is provided for the creation of a registration form. In this preferred embodiment, fields are created for user entry on a website. Users submit their name, email, phone number, license plate state and number, and create a login and password.

```
form_for @user do|f|
= f.error_messages
%fieldset
%ul
  %li
    = f.label :name,  ‘Name’
    = f.text_field :name
  %li
    = f.label :email,  ‘Email for email notifications’
    = f.text_field :email
  %li
    =  f.label  :phone,  ‘Phone  Number  for  SMS  or
    MMS notifications’
    = f.text_field :phone
  %li
    = label_tag :state, ‘License State (eg. CA, TX or MA)’
    = text_field_tag :state, @plate.state
  %li
    = label_tag :plate, ‘License Plate’
    = text_field_tag :plate, @plate.number
  %li
    = f.label :login, ‘Login’
    = f.login_field :password
  %li
    = f.label :password, ‘Password’
    = f.password_field :password
  %li
    = f.label :password_confirmation, ‘Confirm Password’
    = f.password_field :password_confirmation
  %li
    = submit_tag ‘Sign up’
```

Sample source code, developed in Ruby on Rails, is provided for creation of a registered user using the submissions from the registration form. In this preferred embodiment, a new user is created and a license plate is associated with the user.

```
def new
  @user = User.new
  @plate = Plate.new
end
def create_new_user
  @plate  =  Plate.create  :number  =>  params[:plate],  :state =>
  params[:state]
  @user = User.new(params[:user])
  @user.plate = @plate
  if @user && @user.valid?
    if @user.not_using_openid?
      @user.register!
    else
      @user.register_openid!
    end
  end
  if @user.errors.empty?
    successful_creation(@user)
  else
    failed_creation
  end
end
```

The vehicle identifier is the means by which the first user 105 can identify the second user 115 to send the message. It can be the license plate of the second user's vehicle and may also include the state that issued the license plate as well as the license plate number. Alternatively, it may be a unique designator or set of designators comprising alphanumeric strings or other strings of symbols, associated with a vehicle or set of vehicles. The vehicle identifier may also be located on a sticker or placard that has been attached to the vehicle. Because a first user 105 often times has no other identifying information about the second user 115, the vehicle identifier plays an important role in providing the first user 105 with information to send the message to the second user 115. The vehicle identifier may be located on a sticker or placard that instructs the first user 105 how to contact the second user 115. The placard may state, “To talk to me, send a text message to 12345 with [State] [License Plate Number] then your message.” The state and license plate number act as a vehicle identifier. Additionally, the first user 105 is instructed how to send the message 110 to the second user 115 including an appropriate format of the message.

In another embodiment, the placard may state “Visit www.txtli.com to send a message to Vehicle 12345.” The number 12345 is acting as a vehicle identifier. Additionally, the first user 105 is instructed how to send the message 110 to the second user 115.

In another embodiment, the first user 105 may use a mobile application, such as one on a smartphone, to send a message 110 to the second user 115. The mobile application may include a method to photograph a license plate or other vehicle identifier attached to a vehicle, automatically recognize such identifier, and allow the first user 105 to send a message to the second user 115 without typing the vehicle identifier into the mobile device. Additionally, the mobile application may contain pre-formatted, “canned” messages or images (including emoticons) so that the first user 105 does not need to type out the entire message 110 to the second user 115.

In the preferred embodiment, the computer can host a website or web application, standalone application, or an application on an ASP. The computer can receive the message 110 from the first user 105 via a sms or mms message, IM, telephone call, or email or directly via an applicable application's user interface 115.

In an embodiment where the first user 105 accesses the website or other application directly to send the message, the user interface 120 consists of fields allowing the first user 105 to input the vehicle identifier and message to be sent. The vehicle identifier fields can consist of a state and license plate field, a designator field corresponding to the unique designator on the sticker or placard that has been applied to the vehicle, or some other unique designator field associated with the vehicle. The message field is a single or set of fields that allow the first user 105 to enter the message that he wishes to send to the second user 115. In such an embodiment, the user interface 120 receives the vehicle identifier, which may consist of a state and license plate number or another unique designator and message, and stores them separately.

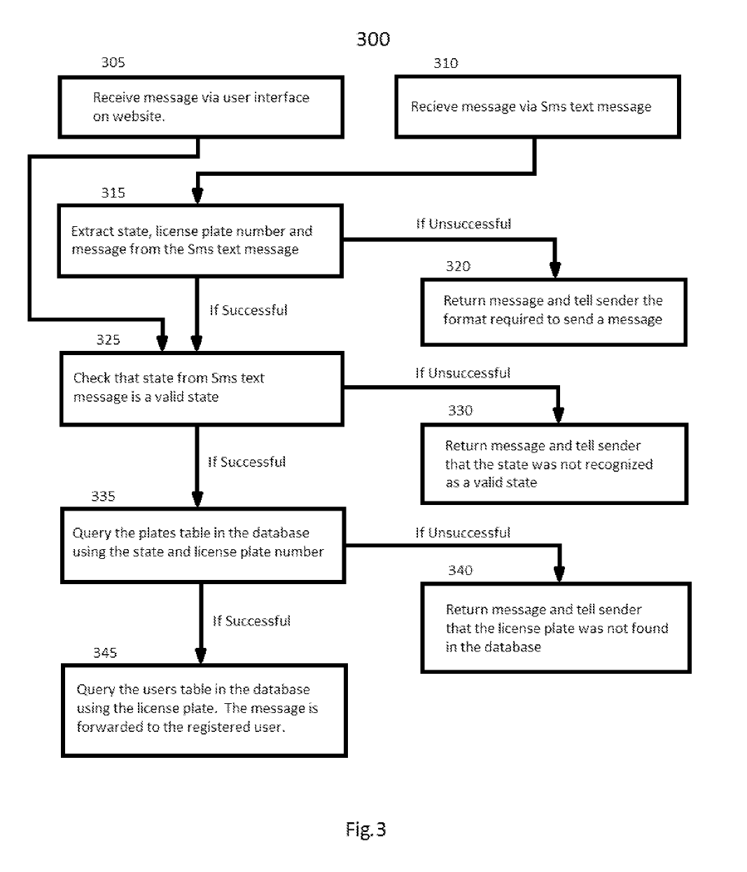

In the embodiment where the computer receives a sms or mms message, IM, or email, the computer must break the message into parts, parse the message. When a message is sent in the format [State][License Plate Number][Message], the message processor 130 separates the state, license plate number and message from a single message string that has been received. The message processor 130 determines if the message 110 was sent in a valid format as instructed by the vehicle identifier. Only messages sent in such a format can be relayed to a second user 115. Invalid messages cannot be relayed to the second user 115 and the first user 105 is informed that the message could not be sent to the second user 115. These messages differ depending on the reason that the message was determined to be invalid, further described below in the FIG. 3 description.

The computer then queries the database 135 using vehicle identifier to determine the identity of the second user 115. If the vehicle identifier appears in the database, the registered user corresponding to that vehicle identifier as well as the user's contact information is retrieved. The contact information can be the second user's mobile phone number, email address, IM address, or ASP identity, in-vehicle device number, or another communications device designator.

This contact information is then used by the computer to relay the message 140 to the second user 115. This is done via sms or mms message, electronic mail, IM, telephone voice network, or an ASP, including social network applications, depending on what contact information is stored in the database 130.

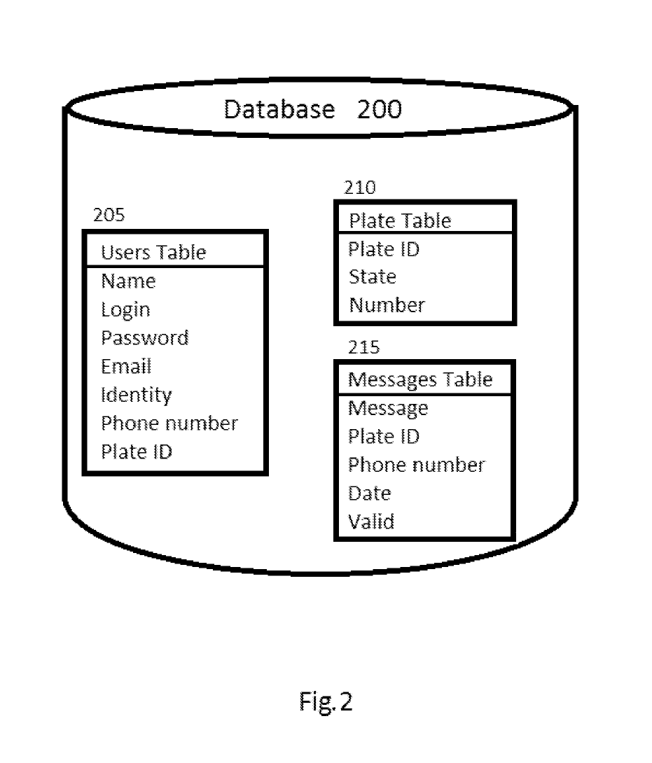

As illustrated in FIG. 2, in the preferred embodiment, database 200 consists of a Users table 205, a Plates table 210 and a Messages table 215.

The Users table 205 stores the information of registered or pre-populated users, which may correspond to a potential second user 130 from FIG. 1 who receives messages from the computer or to a first user 105 from FIG. 1 who sends a message. The table consists of the name of the user, and may include login and password information. The login and password information, if used, allows the user to securely access messages and other information from the website or application. Additionally, the users table may include the electronic mail address, phone number, IM address, ASP identity, in-vehicle device number, or other communications device designator, which is used to relay the received messages to the second user 130 from FIG. 1.

Lastly, the users table may contain the license plate ID referring to the license plate the user has registered.

Sample content for a row in the Users table is provided.

### Name: John Smith

Login: jsmith

### Password: 12345

Email: jsmith@emailme.com

### Phone: 555-555-5555

Identity: jsmith@twitter.com

### Plate ID: 1234

In other embodiments, the Users table may also contain another vehicle designator ID, such as a VIN number, which may or may not be attached to the vehicle by a sticker or placard, instead of or in addition to the license plate ID.

The Plates table 210 stores all registered license plates and/or other vehicle designators and refers to the registered plate and/or other vehicle designators from the Users table 205. A plate ID or other vehicle designator ID links the Plates table with the Users table. A plate consists of a state code and license plate number. Multiple license plates can be registered to the same user. Additionally, a portion of a vehicle designator—for instance, the first three alphanumeric characters of a six-character designator—may be associated to multiple users, particularly in the event the first user 105 from FIG. 1 desires to send a message simultaneously to multiple second users in an alternative embodiment.

Sample content for a row in the Plates table is provided.

### Plate ID: 1234

### State: CA

### Number: ABC123

The Messages Table 215 stores all messages received by the computer from any first user 105 from FIG. 1. A message may consist of the phone number it was sent from, if it was sent as a sms or mms message, or via a telephone voice network, or the email or IM address, ASP identity, or other communications device designator, if it was sent via a standard data network. The table contains the license plate ID or other vehicle designator ID, linking the Messages table with the Users and Plates tables. There is a field to store the message content. The date and time the message was received are also stored. The table also contains information on whether the message was sent in a valid format and successfully relayed to a second user 130 from FIG. 1.

Sample content for a row in the Messages table is provided.
Message: Lights left on

### Datetime: 2011-01-01 11:00:00

### Plate ID: 1234

### Phone: 444-444-4444

### Valid: Yes

As illustrated in FIG. 3, a flow chart 300 showing how a message is processed to be relayed to a registered user is provided.

In an embodiment 310, the computer receives a message sent [State][License Plate Number][Message] via sms text message. As noted above, in other embodiments, the message may be in a number of other formats, such as email, mms, IM, or voice call, and the vehicle designator may be any suitable string of symbols associated with a vehicle. In operation in this embodiment, 315 the computer attempts to extract the state, license plate number and message from a single message string. It looks for a string beginning with a 2 character state code, e.g. “CA”, followed by a whitespace character, a license plate number, followed by whitespace character, followed by the rest of the message. If the message string cannot be separated into State, License Plate Number and Message, operation 320 returns the message and tells the user that the message format is not valid and tells the user that the valid format is [State][License Plate Number][Message], ending the process. If successful, the computer populates and stores the State, License Plate Number and Message variables.

In another embodiment 305, the user enters the state, license plate number and message directly into one or more fields on the user interface of the website or application, including a mobile application running on a user's phone or in-vehicle device. In the event there are separate field directly corresponding to state, license plate number, and message, then operations 315 and 320 are not needed to parse the message in such an embodiment. Instead, the computer reads the fields to populate and store the state, license plate number and message variables.

Next, operation 325 attempts to verify that the State value is a valid state code. It looks at the 2 character state value and it compares it to a list of all 2 character state codes. If the State value is not a valid state code, operation 330 returns the message and tells the user that the State value was not recognized as a valid state code, ending the process. If successful, the query returns the State value.

Next, operation 335 queries the Plates table in the database using the state and license plate number. It looks for an entry in the table for the state and license plate number combination. If no record is found matching the state and license plate number, operation 340 returns a message and tells the user that the license plate was not found in the database, ending the process. If successful, the query returns the license plate ID.

Next, operation 345 queries the Users table in the database using the license plate ID. It looks for an entry in the table for license plate ID. If referential integrity of the database has been maintained, the query will always return a user and a preferred method of forwarding the message. The message is forwarded to the registered user via sms or mms message, IM, telephone voice call, electronic mail, or an ASP, such as a social networking application. The user who sent the message is informed that the message was relayed to the second user successfully.

Sample source code, developed in Ruby on Rails, for the process outlined in FIG. 3 is provided. In this preferred embodiment, the message arrives as a single string. The message is parsed; then, the state value is matched with a state code; then the state and license number are matched to a license plate. If any of these steps are unsuccessful, the first user is informed. If every step is successful, the message is relayed to the second user.

```
state, number, message = extract(body)
if ![state,number,message].all?
  fail_with(body,  “TXTLI.com:  The  message  format  is  not  valid
  format.  Your message must start with the state code then the
  plate e.g. CA 1234ABC Lights left on.”)
elsif state_not_recognized?(state)
  fail_with(body,  “TXTLI.com:  Didn't  recognize  the  state  code
  #{state}.  Your  message  must  start with  the  state  code  then
  the plate e.g. CA 1234ABC Lights left on.”)
else
  plate  =  Plate.find_by_state_and_number(state.upcase,
  number.upcase)
  if plate.nil?
    fail_with(body,  “TXTLI.com:  Sorry,  no  record  of  the  plate
    #{number} in  the  system.  You  might  like  to  double-check  and
    try again.”)
  else
    succeed_with(phone, message, plate)
  end
end
def self.state_not_recognized?(state)
  STATES = %w[AL AK AZ AR CA CO CT DE DC FL GA HI ID
  IL IN IA KS KY LA ME MD MA MI MN MS MO MT NE NV NH
  NJ NM NY NC ND OH OK OR PA RI SC SD TN TX UT VT
  VA WA WV WI WY]
  !STATES.include? state.upcase
end
def self.fail_with(body, response)
  Message.create(:message => body, :invalid_reason => response)
end
def self.succeed_with(phone, message, plate)
  user = User.find_by_plate_id plate.id
  if user.nil?
    logger.error  “Missing  a  user  for  plate  #{plate.id}!”
  else
    logger.info  “Sending  a  text  to  #{user.phone}  with  message
    ‘#{message}’”
  end
  Message.create(:phone => phone,  :message => message,  :plate_id
  => plate.id)
end
```

That which is claimed is:

1. A system, comprising:
A computer for receiving a message from a first user, wherein the computer relays the message to a second user based upon a vehicle identifier.
